(19) United States
(12) Patent Application Publication
(10) Pub. No.: US 2017/0147096 A1
(43) Pub. Date: May 25, 2017

(54) MOUSE PAD STRUCTURE

(71) Applicant: Hades-Gaming Corporation, NEW TAIPEI CITY (TW)

(72) Inventor: Hung-Jen CHOU, NEW TAIPEI CITY (TW)

(21) Appl. No.: 15/063,041

(22) Filed: Mar. 7, 2016

(30) Foreign Application Priority Data
Nov. 24, 2015 (TW) 104138877

(51) Int. Cl. G06F 3/039

(52) U.S. Cl. CPC G06F 3/0395

(57) ABSTRACT

A mouse pad structure includes a pad body and a plastic film. The pad body is formed as a flat plate member and formed with a top surface, a bottom surface opposite to the top surface, and an outer periphery defined between the top surface and the bottom surface. The plastic film is flatly adhered and covered on the top surface and the outer periphery of the pad body. Accordingly, the mouse pad structure is able to provide comfortable operation feelings and increase the movement accuracy defined when a mouse device is operated thereon.

### BACKGROUND OF THE INVENTION

Field of the Invention

The present invention relates to a computer accessory for inputting data, especially to a mouse pad structure.

Description of Related Art

An optical mouse device is commonly used as a computer accessory, the optical mouse device emits LED lights to a mouse pad, and the lights are reflected and then refracted through a lens to a sensor, so the movement and moving direction of the mouse device can be detected. For an optical mouse device, a mouse pad is only for assisting the mouse device to move, the mouse pad is also served as an important reflection interface assisting an optical sensor to receive data. Thus, a proper mouse pad plays an important role regarding to the operation convenience.

In addition, a surface layer of the conventional mouse pad adopts a fabric providing softer touching feelings, so a better operation feeling when operating the mouse device is provided. However, after the fabric on the surface layer of the mouse pad has been used for a long period of time, the fabric may be slightly peeled off or separated from the pad body, thus the operation and the appearance may be affected. Moreover, when the surface layer of the mouse pad adopts a rigid sheet member such as a plastic film, sharp edges are formed at the periphery of the surface layer of the mouse pad. When a user's hand closely contacts the surface layer of the mouse pad and moves thereon, the user may feel uncomfortable after contacting and rubbing against the sharp edges for a long time.

Accordingly, the applicant of the present invention has devoted himself for improving the mentioned disadvantages.

### SUMMARY OF THE INVENTION

The present invention is to provide a mouse pad structure, which provides comfortable operation experiences and allows a mouse device to be precisely operated thereon.

Accordingly, the present invention provides a mouse pad structure, which includes a pad body and a plastic film. The pad body is formed as a flat plate member and formed with a top surface, a bottom surface opposite to the top surface, and an outer periphery defined between the top surface and the bottom surface. The plastic film is flatly adhered and covered on the top surface and the outer periphery of the pad body.

The present invention is to provide a mouse pad structure, in which a pattern layer is disposed between a pad body and a plastic film, and the texture of the pattern layer can be altered according to actual needs, so that the practicability can be increased.

The present invention is to provide a mouse pad structure, in which a plurality of textures are formed on a plastic film, so when an optical mouse device is used thereon, the movement accuracy of an optical mouse device can be enhanced, so that the practicability can be increased.

In comparison with related art, the present invention has advantageous features as follows. According to the mouse pad structure provided by the present invention, the plastic film is combined with the pad body, and the plastic film is flatly adhered on the top surface and the outer periphery of the pad body for covering the sharp edges formed on the pad body; thus, when a user's hand closely contacts the sharp edges, uncomfortable operation feelings can be avoided after rubbing against the sharp edges for a long period of time.

### BRIEF DESCRIPTION OF DRAWING

FIG. 1 is a perspective exploded view showing a mouse pad structure according to one embodiment of the present invention;

FIG. 2 is a perspective view showing the assembly of the mouse pad structure according to one embodiment of the present invention;

FIG. 3 is a partial cross sectional view showing the assembly of the mouse pad structure according to one embodiment of the present invention;

FIG. 4 is a perspective exploded view showing a mouse pad structure according to another embodiment of the present invention;

FIG. 5 is a partial cross sectional view showing the assembly of the mouse pad structure according to another embodiment of the present invention; and

FIG. 6 is a perspective exploded view showing a mouse pad structure according to one another embodiment of the present invention.

### DETAILED DESCRIPTION OF THE INVENTION

Preferred embodiments of the present invention will be described with reference to the drawings.

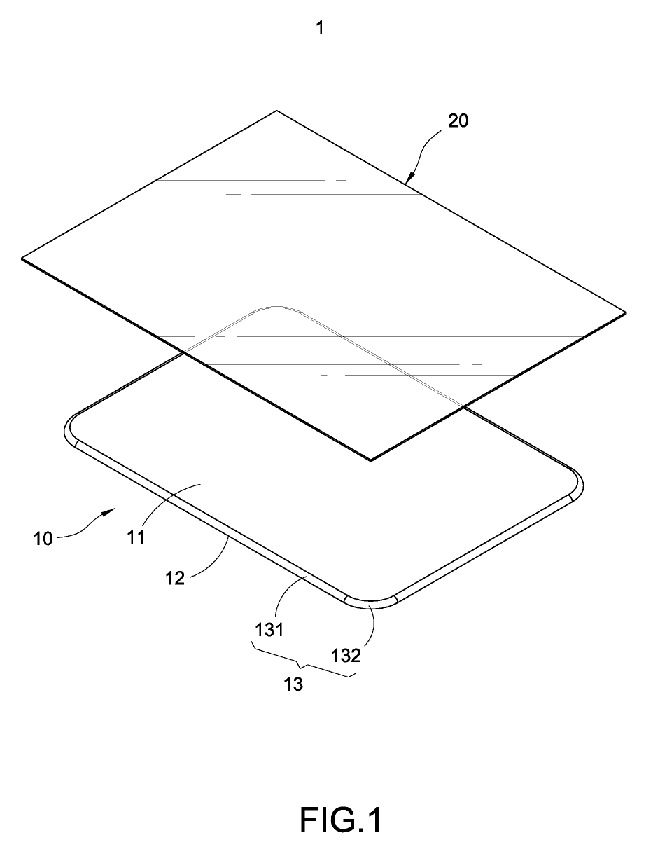

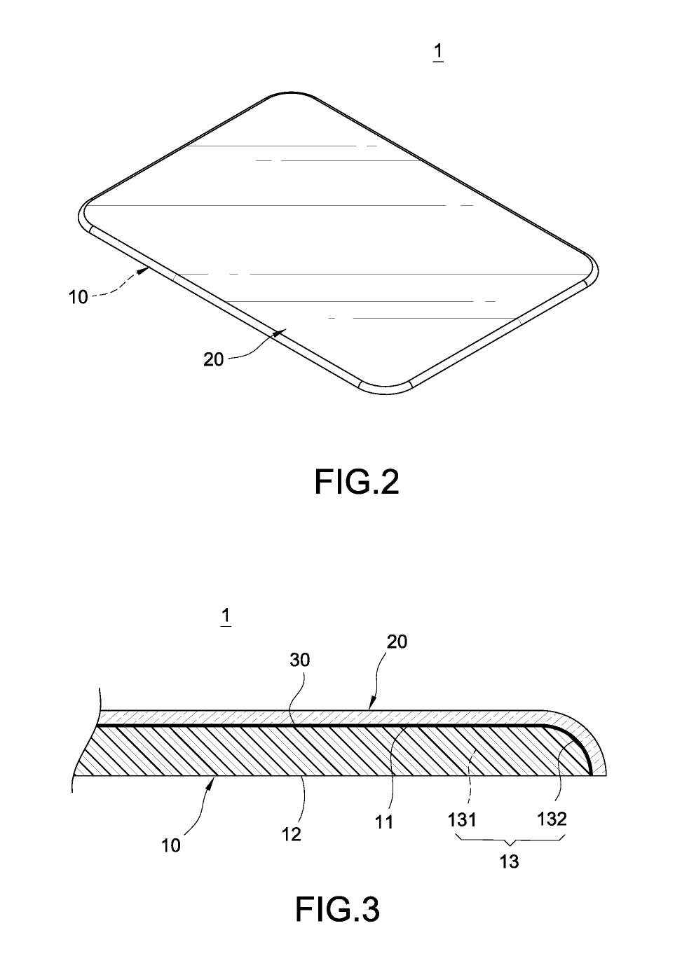

Please refer from FIG. 1 to FIG. 3, wherein FIG. 1 is a perspective exploded view showing a mouse pad structure according to one embodiment of the present invention; FIG. 2 is a perspective view showing the assembly of the mouse pad structure according to one embodiment of the present invention; and FIG. 3 is a partial cross sectional view showing the assembly of the mouse pad structure according to one embodiment of the present invention. The present invention provides a mouse pad structure 1, which includes a pad body 10 and a plastic film 20. The plastic film 20 is combined with the pad body 10, so that the mouse pad structure 1 is formed and capable of being used with a mouse device.

The pad body 10 is formed as a flat plate member and made of a material such as silicon, rubber and sponge, and the above-mentioned material can be selectively adopted according to actual needs. The pad body 10 is formed with a top surface 11, a bottom surface 12 opposite to the top surface 11, and an outer periphery 13 defined between the top surface 11 and the bottom surface 12.

According to this embodiment, the pad body 10 is formed as a rectangular plate member, the outer periphery 13 is formed with a plurality of linear edges 131 and a plurality of curved edges 132, and each of the curved edges 132 is formed between every two of the adjacent linear edges 131. What shall be addressed is that, in actual practice, the shape of the pad body 10 and the outer periphery 13 is not limited to the above-mentioned arrangement.

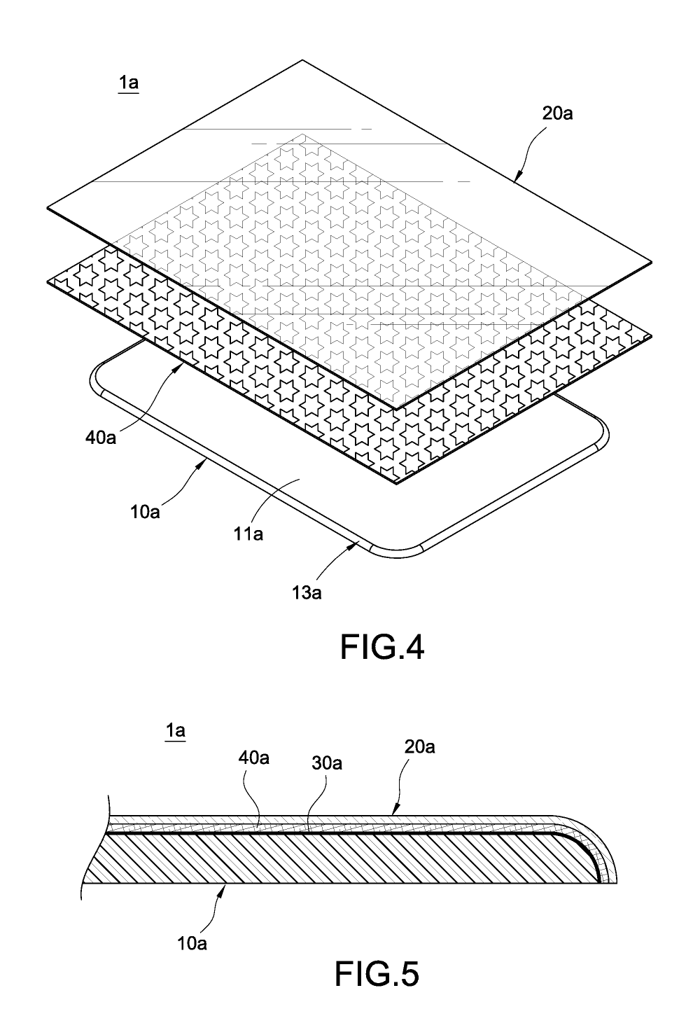

The plastic film 20 is flatly adhered and covered on the top surface 11 and the outer periphery 13 of the pad body 10. According to one embodiment of the present invention, the mouse pad structure 1 further includes a bridging agent 30. The plastic film 20 is combined with the top surface 11 of the pad body 10 through the bridging agent 30. Accordingly, when the outer periphery 13 of the pad body 10 is formed as a sharp edge, the plastic film 20 is able to be served to cover the sharp edge and prevent the sharp edge from being exposed, so that the sharp edge can be avoided from being touched which may cause unpleasant operating feelings. Please refer to FIG. 4 and FIG. 5, wherein FIG. 4 is a perspective exploded view showing a mouse pad structure according to another embodiment of the present invention; and FIG. 5 is a partial cross sectional view showing the assembly of the mouse pad structure according to another embodiment of the present invention. This embodiment is substantially the same as the previous embodiment. According to this embodiment, the present invention provides a mouse pad structure 1a, which includes a pad body 10a, a plastic film 20a and a bridging agent 30a. The plastic film 20a is combined with the pad body 10a and flatly adhered and covered on a top surface 11a and an outer periphery 13a of the pad body 10a, so that the mouse pad structure la is formed.

The difference between this embodiment and the previous embodiment is that the mouse pad structure la further includes a pattern layer 40a which is disposed between the pad body 10a and the plastic film 20a. According to this embodiment, the plastic film 20a is formed as a light-pervious sheet member, and the texture of the pattern layer 40a can be altered according to actual needs, so that the practicability can be increased.

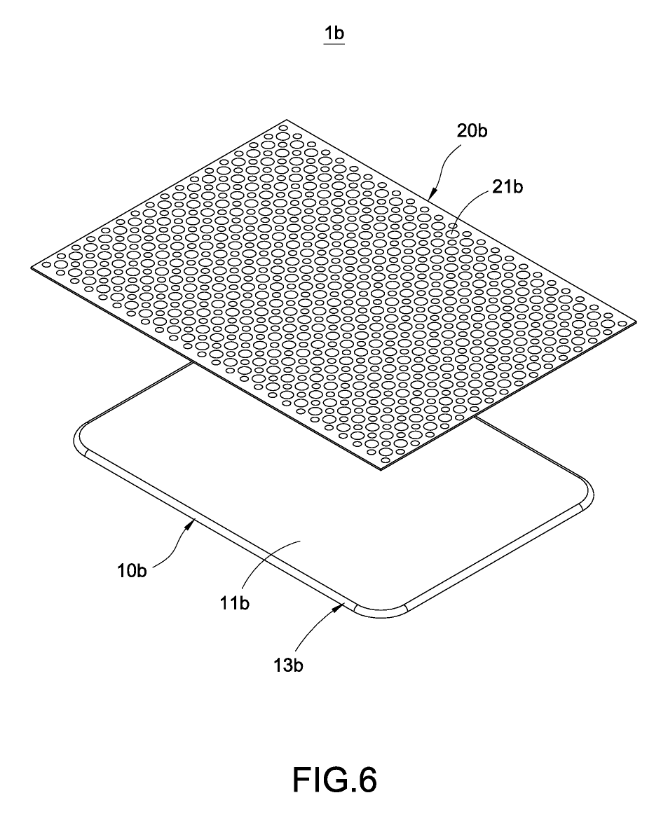

Please refer to FIG. 6, which is a perspective exploded view showing a mouse pad structure according to one another embodiment of the present invention. This embodiment is substantially the same as the previous embodiment. According to this embodiment, the present invention provides a mouse pad structure lb, which includes a pad body 10b and a plastic film 20b. The plastic film 20b is combined with the pad body 10b and flatly adhered and covered on a top surface 11b and an outer periphery 13b of the pad body 10b.

According to this embodiment, the plastic film 20b is formed with a plurality of textures 21b. When an optical mouse device is used on the mouse pad structure 1b, the textures 21b are able to increase the accuracy defined when the optical mouse device is operated, so that the practicability can be increased.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mouse pad structure, including:
a pad body, formed as a flat plate member and formed with a top surface, a bottom surface opposite to the top surface, and an outer periphery defined between the top surface and the bottom surface; and
a plastic film, flatly adhered and covered on the top surface and the outer periphery of the pad body.

2. The mouse pad structure according to claim 1, wherein the pad body is made of silicon, rubber or sponge.

3. The mouse pad structure according to claim 1, wherein the outer periphery is formed with a plurality of curved edges.

4. The mouse pad structure according to claim 1, further including a bridging agent, and the plastic film being combined with the top surface of the pad body through the bridging agent.

5. The mouse pad structure according to claim 1, wherein the plastic film is a light-pervious sheet member.

6. The mouse pad structure according to claim 5, further including a pattern layer, and the pattern layer being disposed between the pad body and the plastic film.

7. The mouse pad structure according to claim 1, wherein the plastic film is formed with a plurality of textures.
